(19) United States
(12) Patent Application Publication
(10) Pub. No.: US 2026/0006040 A1
(43) Pub. Date: Jan. 1, 2026

(54) SYSTEM AND METHOD FOR DETECTING ANOMALIES WITHIN AN AVIONICS AND VETRONICS NETWORK

(71) Applicant: Honeywell International Inc., Charlotte, NC (US)

(72) Inventors: John Allen, New Brighton, MN (US); William Dalzell, Parrish, FL (US)

(21) Appl. No.: 18/755,755

(22) Filed: Jun. 27, 2024

(51) Int. Cl. H04L 9/40

(52) U.S. Cl. CPC H04L 63/1416

(57) ABSTRACT

A method for detecting and attributing the cause of anomalies within a cyber-physical system such as in avionics or vetronics network is disclosed. The method comprises monitoring, via at least one processor, data of one or more components within the avionics and vetronics network in real time; determining, via the at least one processor, one or more anomalies from the monitored data using a condition-based maintenance model and a cyber-defense model; determining, via the at least one processor, whether the one or more anomalies is related to a cascading fault using the condition-based maintenance model and the cyber-defense model; determining, via the at least one processor, the one or more anomalies corresponding to a component failure or an evidence of the cyberattack; and generating, via the at least one processor, one or more alerts for a user associated with the one or more anomalies.

### TECHNOLOGICAL FIELD

The present invention relates to health and monitoring of cyber-physical systems such as avionics and vetronics networks, and more particularly relates to a system and method for detecting and attributing the cause of anomalies within these networks using a condition-based maintenance model and a cyber-defense model.

### BACKGROUND

Over the past so many years, machines have evolved from purely mechanical devices into cyber-mechanical devices that are composed of both electrical and mechanical components. The mechanical components make changes in the world such as moving from one location to another, adjusting temperatures i.e., lowering a temperature, or building furniture. Further, electronic, or cyber portion are used to control mechanical portions such as specifying precise movements. For example, a vehicle's steering system that restricts wheel turn based on a vehicle's speed, or an airliner's system for sensing and dampening turbulence in a commercial airliner. The development of cyber-mechanical devices has paralleled the development of the internet, with some significant differences. The internet was primarily concerned with the management and transport of information. While delivery of the information to a destination was important, the exact timing of information delivery was not tightly subscribed. However, in cyber-physical systems deliver times are often a requirement for the systems to safely perform the tasks.

Avionics and vetronics systems are electronic frameworks that powers modern aircraft and military vehicles, respectively. Such systems include a wide range of functionalities, from navigation and communication to control and monitoring of vehicle performance. The Avionics, derived from “aviation electronics” and Vetronics, derived from “vehicle electronics”. The avionics generally refers to the data buses and flight systems such as actuation controllers, Flight Management System (FMS), or auto-pilots. The vetronics offer integrated systems including data buses and control systems such as electronic ignition, steering, and entertainment systems. Both avionics and vetronics are crucial for the optimal performance and safety of their respective platforms. The avionics and vetronics systems are increasingly interconnected with external networks. Such interconnectivity often exposes the avionics and vetronics systems to a broad range of cyberattacks or cyber threats traditionally associated with information technology (IT) infrastructure. Beyond the familiar cyberattacks like malware, phishing, and network breaches, the avionics and vetronics systems face unique vulnerabilities due to their embedded nature and critical functions. The avionics and vetronics systems are particularly susceptible to non-traditional attack vectors, such as introduction of counterfeit components through compromised supply chains. The requirement for securing the avionics and vetronics systems are extraordinarily high, as disruptions can lead to severe outcomes, including significant loss of life.

The inventors have identified numerous areas of improvement in the existing technologies and processes, which are the subjects of embodiments described herein. Through applied effort, ingenuity, and innovation, many of these deficiencies, challenges, and problems have been solved by developing solutions that are included in embodiments of the present disclosure, some examples of which are described in detail herein. The inventors improvements are envisioned to be of benefit to other aligned industries including ground and sea based system that require similar validation of who is controlling and if the requested control is counter to the mission of the systems under control

### BRIEF SUMMARY

The following presents a simplified summary in order to provide a basic understanding of some aspects of the present disclosure. This summary is not an extensive overview and is intended to neither identify key or critical elements nor delineate the scope of such elements. Its purpose is to present some concepts of the described features in a simplified form as a prelude to the more detailed description that is presented later.

In one example embodiment, a method for detecting anomalies within a cyber-physical system is disclosed. The method comprising monitoring, via at least one processor, data of one or more components within the cyber-physical system in real time. The data comprises at least one of flight data, vehicle data, navigation data, communication data, status data, safety data, and combat and tactical data. Further, the method comprises determining, via the at least one processor, one or more anomalies from the monitored data using a condition-based maintenance model and a cyber-defense model. Further, the condition-based maintenance model and the cyber-defense model are configured to determine unexpected behaviors in the data representing component failure and an evidence of a cyberattack respectively, within the cyber-physical system. Further, the method comprises determining, via the at least one processor, whether the one or more anomalies is related to a cascading fault using the condition-based maintenance model and the cyber-defense model. Further, the cascading fault corresponds to a sequence of failures of the one or more components within the cyber-physical system. Further, the method comprises determining, via the at least one processor, the one or more anomalies corresponding to a component failure within the cyber-physical system upon determining the one or more anomalies are related to the cascading fault or the one or more anomalies corresponding to the evidence of the cyberattack within the cyber-physical system upon determining the one or more anomalies are not related to the cascading fault. Thereafter, the method comprises, generating, via the at least one processor, one or more alerts for a user associated with the one or more anomalies, upon determining that the one or more anomalies correspond to the component failure or the evidence of the cyberattack.

In some embodiments, the one or more components of the cyber-physical system comprises at least one of a flight control module, a navigation module, a communication module, a surveillance and monitoring module, a weather module, a safety and alerting module, and an engine monitoring module.

In some embodiments, the one or more anomalies correspond to at least one of test information, faults and interrupts in bus, disordering of communications, memory footprint of devices within the cyber-physical system, communication timing, contents within packet moving back and forth within the cyber-physical system.

In some embodiments, the component failure corresponds to an abnormal behavior or breakdown of the one or more components within the cyber-physical system. In some embodiments, the evidence of the cyberattack corresponds to interference, disruption, malfunction, or compromise of the one or more components caused by cyber threats such as hacking, malware, or other forms of cyberattacks.

In some embodiments, the method further comprises displaying, via the at least one processor, the one or more alerts to the user, for taking an appropriate action in response to the one or more anomalies determined within the cyber-physical system. In some embodiments, the one or more alerts comprise at least one of visual alerts, auditory alerts, textual alerts, tactile alerts, or remote alerts.

In another example embodiment, a system for detecting anomalies within the cyber-physical system is disclosed. The system comprises a memory and at least one processor communicatively coupled to the memory. The at least one processor is configured to monitor data of one or more components within an cyber-physical system in real time. The data comprises at least one of flight data, vehicle data, navigation data, communication data, status data, safety data, and combat and tactical data. Further, the at least one processor is configured to determine one or more anomalies from the monitored data using a condition-based maintenance model and a cyber-defense model. Further, the condition-based maintenance model and the cyber-defense model are configured to determine unexpected behaviors in the data representing component failure and an evidence of a cyberattack respectively, within the cyber-physical system. Further, the at least one processor is configured to determine whether the one or more anomalies is related to a cascading fault using the condition-based maintenance model and the cyber-defense model. Further, the cascading fault corresponds to a sequence of failures of the one or more components within the cyber-physical system. Further, the at least one processor is configured to determine the one or more anomalies corresponding to a component failure within the cyber-physical system upon determining the one or more anomalies are related to the cascading fault or the one or more anomalies corresponding to the evidence of the cyberattack within the cyber-physical system upon determining the one or more anomalies are not related to the cascading fault. Thereafter, the at least one processor is configured to generate one or more alerts for a user associated with the one or more anomalies, upon determining that the one or more anomalies correspond to the component failure or evidence of the cyberattack.

In another example embodiment, a non-transitory machine-readable information storage medium for detecting anomalies within the cyber-physical system using a condition-based maintenance and a cyber-defense model is disclosed. The non-transitory machine-readable information storage medium comprising one or more instructions which when executed by at least one processor cause the at least one processor to monitor data of one or more components within the cyber-physical system in real time, wherein the data comprises at least one of flight data, vehicle data, navigation data, communication data, status data, safety data, and combat and tactical data; determine one or more anomalies from the monitored data using a condition-based maintenance model and a cyber-defense model, wherein the condition-based maintenance model and the cyber-defense model are configured to determine unexpected behaviors in the data representing component failure and evidence of the cyberattack respectively, within the cyber-physical system; determine whether the one or more anomalies is related to a cascading fault using the condition-based maintenance model and the cyber-defense model, wherein the cascading fault corresponds to a sequence of failures of the one or more components within the cyber-physical system; determine the one or more anomalies corresponding to a component failure within the cyber-physical system upon determining the one or more anomalies are related to the cascading fault or the one or more anomalies corresponding to evidence of the cyberattack within the cyber-physical system upon determining the one or more anomalies are not related to the cascading fault; and generate one or more alerts for a user associated with the one or more anomalies, upon determining that the one or more anomalies correspond to the component failure or the evidence of the cyberattack.

The above summary is provided merely for purposes of summarizing some example embodiments to provide a basic understanding of some aspects of the invention. Accordingly, it will be appreciated that the above-described embodiments are merely examples and should not be construed to narrow the scope or spirit of the invention in any way. It will be appreciated that the scope of the invention encompasses many potential embodiments in addition to those here summarized, some of which will be further described below.

### BRIEF DESCRIPTION OF THE DRAWINGS

Having thus described certain example embodiments of the present disclosure in general terms, reference will hereinafter be made to the accompanying drawings, which are not necessarily drawn to scale, and wherein:

FIG. 1 illustrates a network diagram of a system for detecting anomalies within an cyber-physical system in accordance with an example embodiment of the present disclosure;

FIG. 2A illustrates a block diagram of the server in accordance with an example embodiment of the present disclosure;

FIG. 2B illustrates a block diagram of a cyber physical system architecture with a condition-based maintenance model and a cyber-defense model in accordance with an example embodiment of the present disclosure;

FIG. 3 illustrates a communication architecture of the cyber-physical system in accordance with an example embodiment of the present disclosure;

FIGS. 4A-4B illustrate tables having data associated with an avionics network in accordance with an example embodiment of the present disclosure;

FIGS. 5A-5B illustrate tables having data associated with a vetronics network in accordance with an example embodiment of the present disclosure;

FIG. 6 illustrates a table showing the one or more anomalies determined by the system within the cyber-physical system in accordance with an example embodiment of the present disclosure;

FIG. 7 illustrates a block diagram showing communication among various components within the cyber-physical system in accordance with an example embodiment of the present disclosure; and

FIG. 8 illustrates a flowchart showing a method for detecting anomalies within the cyber-physical system in accordance with an example embodiment of the present disclosure.

### DETAILED DESCRIPTION

Some embodiments will now be described more fully hereinafter with reference to the accompanying drawings, in which some, but not all, embodiments are shown. Indeed, various embodiments may be embodied in many different forms and should not be construed as limited to the embodiments set forth herein; rather, these embodiments are provided so that this disclosure will satisfy applicable legal requirements.

The components illustrated in the figures represent components that may or may not be present in various embodiments of the invention described herein such that embodiments may include fewer or more components than those shown in the figures while not departing from the scope of the invention. Some components may be omitted from one or more figures or shown in dashed line for visibility of the underlying components.

The present disclosure provides various embodiments of methods and systems for detecting anomalies within a cyber-physical system. Embodiments may be configured to monitor data of one or more components within the cyber-physical system in real time. The data may comprise at least one of flight data, vehicle data, navigation data, communication data, status data, safety data, and combat and tactical data associated with the cyber-physical system. The one or more components of the cyber-physical system may comprise at least one of a flight control module, a navigation module, a communication module, a surveillance and monitoring module, a weather module, a safety and alerting module, and an engine monitoring module. Embodiments may be configured to determine one or more anomalies from the monitored data using a condition-based maintenance model and a cyber-defense model. The condition-based maintenance model and the cyber-defense model may be configured to determine unexpected behaviors in the data representing component failure and evidence of the cyberattack respectively, within the cyber-physical system. The one or more anomalies may correspond to at least one of test information, faults and interrupts in bus, disordering of communications, memory footprint of devices within the avionics network, communication timing, contents within packet moving back and forth within the cyber-physical system.

Embodiments may be configured to determine whether the one or more anomalies is related to a cascading fault using the condition-based maintenance model and the cyber-defense model. The cascading fault may correspond to a sequence of failures of the one or more components within the cyber-physical system. Embodiments may be configured to determine the one or more anomalies corresponding to a component failure within the cyber-physical system upon determining the one or more anomalies are related to the cascading fault or the one or more anomalies corresponding to the evidence of the cyberattack within the cyber-physical system upon determining the one or more anomalies are not related to the cascading fault. The component failure may correspond to an abnormal behavior or breakdown of the one or more components within the cyber-physical system. The evidence of the cyberattack may correspond to interference, disruption, malfunction, or compromise of the one or more components caused by cyber threats such as hacking, malware, or other forms of cyberattacks. Embodiments may be configured to generate one or more alerts for a user associated with the one or more anomalies, upon determining that the one or more anomalies correspond to the component failure or the evidence of the cyberattack. The one or more alerts may comprise at least one of visual alerts, auditory alerts, textual alerts, tactile alerts, or remote alerts.

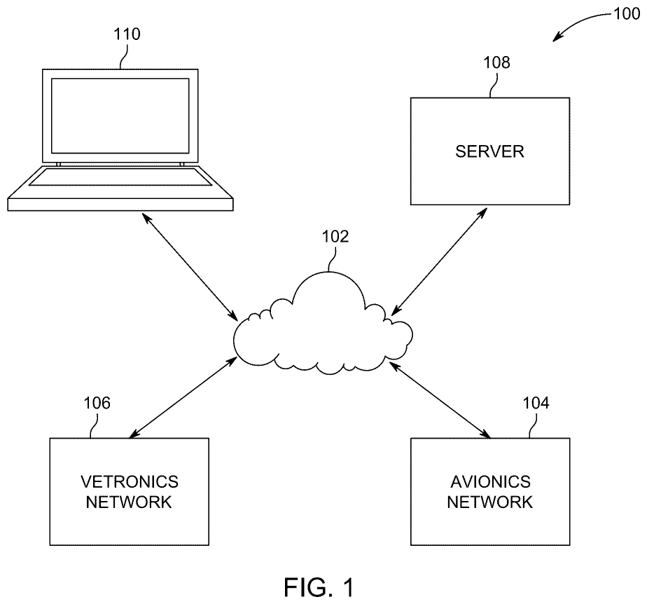

FIG. 1 illustrates a network diagram of a system 100 for detecting anomalies within a cyber-physical system, in accordance with an example embodiment of the present disclosure. In some embodiments, the system 100 may be configured to detect one or more anomalies within a real-time cyber physical system such as avionics or vetronics network. The system 100 may comprise a network 102, an avionics network 104, and a vetronics network 106. The system 100 may further comprise a server 108 and a user device 110.

In some embodiments, the network 102 may be a communication network, such as the Internet or a cloud network, configured to enable communication between various computing devices and processing systems through wired, wireless, or hybrid connections. Further, the network 102 may also correspond to a distributed infrastructure designed for the exchange of data, information, and resources among interconnected computing devices and systems. The network 102 may facilitate communication and collaboration across remote locations, devices, and platforms. Those skilled in the art will understand that wired networks may include, but are not limited to, wired networks such as wide area networks (WANs) or local area networks (LANs). Further, wireless networks, on the other hand, may use wireless communications via radio frequency (RF) signals or infrared signals. Furthermore, various devices within the system 100 may connect to the network 102 using an array of wired and wireless communication protocols, such as Transmission Control Protocol/Internet Protocol (TCP/IP), User Datagram Protocol (UDP), and 2G, 3G, or 4G communication protocols.

In some embodiments, the cyber-physical system may comprise, but is not limited to, the avionics network 104, the vetronics network 106, marine system (not shown), or aerospace system (not shown). In some embodiments, the avionics network 104 may be integrated into one or more applications such as, but are not limited to, aircrafts or spaceships. In some embodiments, the vetronics network 106 may be integrated into one or more applications such as, but are not limited to, military vehicles or civilian vehicles. Further, each of the avionics and vetronics network may be configured to perform one or more operations. In one example, the one or more operations of the avionics network 104 may include, but is not limited to, navigation, communication, engine control, and flight management. In another example, the one or more operations of the vetronics network 106 may include, but is not limited to, vehicle health monitoring, navigation, infotainment, and weaponry management.

In some embodiments, the avionics network 104 may be configured to control and monitor various operations of each of the one or more applications. In one example, the system 100 when integrated into an aircraft, the avionics network 104 may be configured to control one or more operations of the aircraft. Further, the one or more operations may include, but are not limited to, navigation, communication with air-traffic control (ATC), flight management, route planning, fuel management, and performance optimization. In another example, the avionics network 104 may be paired to autopilot systems of the aircraft to ensure a stable and efficient flight by maintaining a desired altitude, heading, and speed. In some embodiments, the avionics network 104 may be configured to enable an efficient data exchange between the aircraft and the ATC.

In some embodiments, the one or more components of the avionics network 104 may comprise at least one of a flight control module, a navigation module, a communication module, a surveillance and monitoring module, a weather module, a safety and alerting module, and an engine monitoring module. Further, the one or more components may be configured to generate data during operations of the avionics network 104. In some embodiments, the data may comprise at least one of flight data, vehicle data, navigation data, communication data, status data, and combat and tactical data. In some embodiments, the one or more components may be configured to perform specific tasks to generate the data during operations of the avionics network 104. In one example, the flight control module of the avionics network 104 may be configured to generate the flight data. Further, the navigation module of the avionics network 104 may be configured to generate the navigation data. Further, the communication module of the avionics network 104 may be configured to generate the communication data.

In some embodiments, the vetronics network 106 may be configured to manage and monitor various operations of the military and civilian vehicles. In one example, when the system 100 is integrated into a military vehicle, the vetronics network 106 may be configured to control one or more operations of the military vehicle. Further, the one or more operations may include navigation, communication, vehicle management, route planning, fuel management, and performance optimization. In another example, the vetronics network 106 may be paired with an advanced driver assistance system to control operations such as cruise control, lane-keeping assist, and collision avoidance.

In some embodiments, the vetronics network 106 may comprise the one or more components. Further, the one or more components within the vetronics network 106 may comprise at least one of the navigation module, the communication module, the surveillance and monitoring module, the weather module, the safety and alerting module, and the engine monitoring module. In some embodiments, the one or more components within the vetronics network 106 may be configured to generate the data. In some embodiments, the data may comprise at least one of the vehicle data, the navigation data, the communication data, the status data, and combat and tactical data. In some embodiments, the one or more components within the vetronics network 106 may be configured to perform specific tasks to generate the data during operations of the vetronics network 106.

In some embodiments, the server 108 may correspond to a computer or software module that is configured to provide centralized resources, data, or services to the avionics and vetronics network. The server 108 may be configured to handle and manage one or more computational tasks and data processing within the system 100. In some embodiments, the server 108 may include storage systems, such as hard drives or storage arrays, to store and manage large volumes of data and information accessible to network users. In some embodiments, the server 108 may further provide centralized control and management capabilities, allowing network administrators to configure, monitor, and maintain network resources, security settings, and user access permissions from a single location.

In some embodiments, the server 108 may be configured to monitor the data of the one or more components within the avionics and vetronics network in the real time. Further, the data may comprise at least one of the flight data, vehicle data, navigation data, communication data, status data, safety data, and combat and tactical data. Further, the one or more components within the avionics and vetronics network may comprise at least one of the flight control module, the navigation module, the communication module, the surveillance and monitoring module, the weather module, the safety and alerting module, and the engine monitoring module.

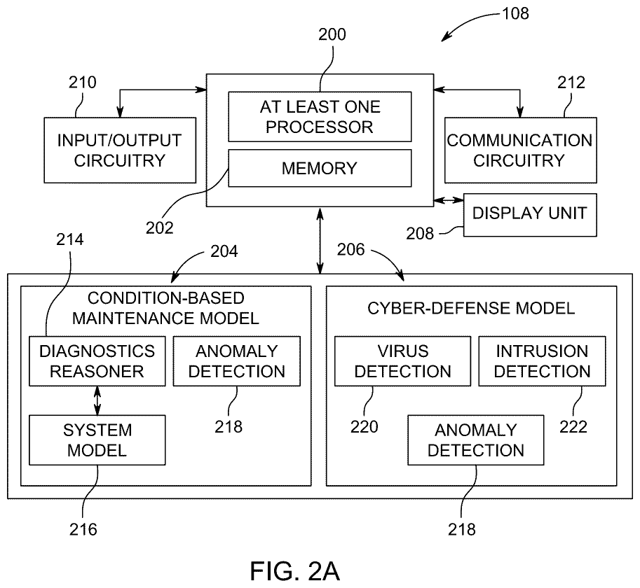

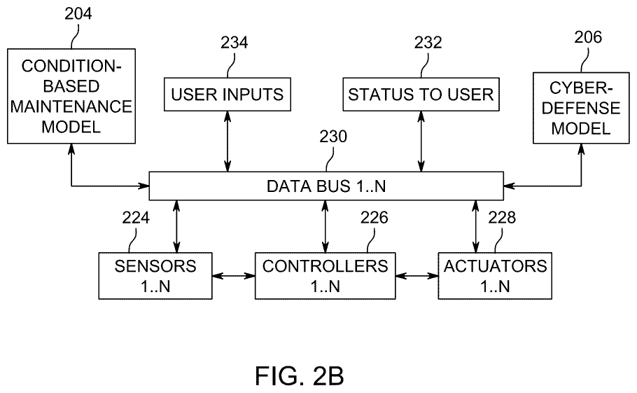

Further, the server 108 may comprise at least one processor (not shown) and a memory (not shown). The memory may be configured to store the data associated with the one or more components of the avionics and vetronics network. In some embodiments, the memory may be configured to store the data after a regular time interval. In some embodiments, the server 108 may be configured to utilize one or more data storage and management techniques. Further, the one or more data storage and management techniques may comprise at least one of a neural networks technique and a blockchain technique. The detailed description of the at least one processor and the memory will be described later in conjunction with FIG. 2A.

In one instance, the neural networks technique may be utilized by the server 108 to store the data into the memory. Further, the neural networks technique may be configured to analyze and categorize a large volume of the data enabling a predictive analytics and anomaly detection within the data. Further, the neural networks technique may facilitate detection of potential failures within the avionics network 104 and vetronics network 106, such as engine failures or unusual patterns in flight or vehicle behavior. In another instance, the blockchain technique may be configured to ensure integrity and security of the data stored within the memory. Further, the blockchain technique may facilitate storage of the data in a form of one or more blocks in the blockchain technique. In one example, the flight data may be stored into one block, the communication data may be stored into another block.

In some embodiments, the server 108 may be configured to determine one or more anomalies from the monitored data using a condition-based maintenance model and a cyber-defense model. Further, the one or more anomalies may correspond to at least one of test information, faults and interrupts in bus, disordering of communications, memory footprint of devices within the avionics network 104, communication timing, contents within packet moving back and forth within the avionics network 104. Further, the condition-based maintenance model and the cyber-defense model may be configured to determine unexpected behaviors in the data representing component failure and an evidence of the cyberattack respectively, within the avionics and vetronics network.

In some embodiments, the server 108 may be configured to determine whether the one or more anomalies is related to a cascading fault using the condition-based maintenance model and the cyber-defense model. In some embodiments, the cascading fault may correspond to a sequence of failures of the one or more components within the avionics and vetronics network. Further, the sequence of failures may depict a scenario when a failure in one component of the one or more components triggers subsequent failures in other interconnected components of the one or more components. Further, the sequence of failures may trigger a chain reaction of failures within the one or more components that may affect performance of the avionics and vetronics network.

In some embodiments, the server 108 may be configured to determine the one or more anomalies corresponding to a component failure within the avionics and vetronics network upon determining the one or more anomalies may relate to the cascading fault. In some embodiments, the server 108 may be configured to determine the one or more anomalies corresponding to an evidence of the cyberattack within the avionics and vetronics network upon determining the one or more anomalies may not relate to the cascading fault.

In some embodiments, the server 108 may be configured to generate one or more alerts for a user associated with the one or more anomalies, upon determining that the one or more anomalies may correspond to the component failure or evidence of the cyberattack. In some embodiments, the server 108 may comprise a display unit (not shown). In some embodiments, the server 108 may be configured to display the one or more alerts to the user over the display unit. In some embodiments, the one or more alerts may comprise at least one of visual alerts, auditory alerts, textual alerts, tactile alerts, or remote alerts. In some embodiments, the display unit may comprise an intrusive interface that may be configured to display the one or more alerts to the user.

In some embodiments, the system 100 may comprise the user device 110. Further, the user device 110 may be communicatively coupled to the avionics and vetronics network through the network 102. In one example, the user device 110 may be configured to display the one or more alerts associated with the one or more anomalies in the avionics and vetronics network. In some embodiments, the user device 110 may be configured to provide a real time insight into working and status of each component of the one or more components of the avionics and vetronics network. Further, the user device 110 may comprise at least one of a mobile phone, tablet, laptop, etc. In some embodiments, the user device 110 may be installed with a user interface (UI) or an application programmable interface (API) that may display the one or more alerts in a readable format that may facilitate the user to take an appropriate action in response to the one or more anomalies determined within the avionics and vetronics network.

In some embodiments, the system 100 may be configured to detect one or more anomalies within a real-time cyber physical system such as the avionics or vetronics network. In one embodiment, the real-time cyber physical system may comprise a control and monitoring system of an oil refinery, a manufacturing plant, etc. Further, the system 100 may be coupled with the control and monitoring system for detecting the one or more anomalies within the control and monitoring system. For example, the control and monitoring system comprises a plurality of critical components such as supervisory control and data acquisition (SCADA), heat exchangers, safety modules, industrial Ethernet network, and wireless communication networks. In some embodiments, the server 108 may be configured to determine the one or more anomalies within the plurality of critical components of the control and monitoring system using the condition-based maintenance model and the cyber-defense model. Further, the server 108 may be configured to determine whether the one or more anomalies of the plurality of critical components is related to the cascading fault using the condition-based maintenance model and the cyber-defense model. Further, the server 108 may be configured to determine the one or more anomalies corresponding to the component failure within the avionics and vetronics network upon determining the one or more anomalies related to the cascading fault. In some embodiments, the server 108 may be configured to determine the one or more anomalies corresponding to the evidence of the cyberattack within the avionics and vetronics network upon determining the one or more anomalies not related to the cascading fault. Further, the server 108 may be configured to generate the one or more alerts for the user, upon determining that the one or more anomalies correspond to the component failure or evidence of the cyberattack.

It will be apparent to one skilled in the art that above-mentioned components of the system 100 have been provided only for illustration purposes, without departing from the scope of the disclosure. It may be noted that the real-time cyber physical system such as the avionics or vetronics network have been provided only for illustration purposes, without departing from the scope of the disclosure.

FIG. 2A illustrates a block diagram of the server 108, in accordance with an example embodiment of the present disclosure. FIG. 2B illustrates a block diagram of a cyber physical system architecture with a condition-based maintenance model and a cyber-defense model, in accordance with an example embodiment of the present disclosure. FIGS. 2A and 2B are described in conjunction with FIG. 1. The server 108 may comprise at least one processor 200, a memory 202, a condition-based maintenance model 204, a cyber-defense model 206, an input/output circuitry 210, and a communication circuitry 212.

In some embodiments, the at least one processor 200 may include suitable logic, circuitry, and/or interfaces that are operable to execute one or more instructions stored in the memory 202 to perform predetermined operations. In one embodiment, the at least one processor 200 may be configured to decode the one or more instructions and execute the one or more instructions that are stored within the memory 202. The at least one processor 200 may be configured to execute one or more computer-readable program instructions, such as program instructions to carry out any of the functions described in this description. Further, the at least one processor 200 may be implemented using one or more processor technologies known in the art such as central processing unit (CPU), field-programmable gate array (FPGA), digital signal processors (DSP), etc. Examples of the at least one processor 200 may comprise at least one of, one or more general purpose processors and/or one or more special purpose processors that may be designed to handle the avionics and vetronics network.

In some embodiments, the at least one processor 200 of the server 108 may be configured to monitor data of the one or more components within the avionics and vetronics network in real time. In one example, the one or more components within the avionics and vetronics network may comprise at least one of the flight control module, the navigation module, the communication module, the surveillance and monitoring module, the weather module, the safety and alerting module, and the engine monitoring module. Further, the data may comprise at least one of flight data, vehicle data, navigation data, communication data, status data, safety data, and combat and tactical data.

In some embodiments, the flight control module may be configured to manage one or more control surfaces of the avionics networks 104. Further, the one or more control surfaces may comprise at least one of ailerons, rudders, and elevators. Further, the one or more control surfaces may be configured to maintain a desired flight paths and stability to ensure a precise maneuvering of an aircraft integrated with the avionics network 104. Further, the navigation module may be configured to provide an accurate positioning, routing, and guidance information to a flight crew of the aircraft. Further, the navigation module may be coupled with a global positioning system (GPS), inertial navigation, and waypoints to ensure the aircraft follows a planned flight path.

In some embodiments, the communication module may facilitate voice and data communication between the aircraft and a ground-control, other aircraft, and onboard systems. Further, the communication module may be configured to ensure a seamless exchange of critical information for safe and efficient operations of the aircraft. In some embodiments, the surveillance and monitoring module may be configured to continuously track and report the aircraft's position, speed, and other critical parameters. Further, the surveillance and monitoring module may facilitate in collision avoidance and situational awareness through automatic dependent surveillance-broadcast (ADS-B) and radio detection and ranging (RADAR).

In some embodiments, the weather module may be configured to gather and process meteorological data to provide a real time weather updates and forecasts. Further, the weather module may facilitate the flight crew to make informed decisions to avoid hazardous weather conditions. Further, the safety and alerting module may be configured to monitor the aircraft's systems and devices for potential issues and alert the flight crew of any abnormalities or emergencies, enabling timely responses to maintain safety and compliance with regulations. Further, the engine monitoring module may be configured to continuously track performance and health of the aircraft's engines. Further, the engine monitoring module may be configured to detect any anomalies or degradations to ensure optimal operation of the aircraft and prevent engine failures.

In some embodiments, the at least one processor 200 may be configured to determine the one or more anomalies from the monitored data. In some embodiments, the at least one processor 200 may employ the condition-based maintenance model 204 and the cyber-defense model 206 to determine the one or more anomalies. The condition-based maintenance model 204 and the cyber-defense model 206 may be configured to determine unexpected behaviors in the data representing component failure and evidence of the cyberattack respectively, within the avionics and vetronics network. In some embodiments, the condition-based maintenance model 204 may be configured to continuously monitor the real time data collected from the one or more components within the avionics and vetronics network. Further, the condition-based maintenance model 204 may be configured to use analytics and machine learning (ML) algorithms to assess the current state and performance of each component of the one or more components of the avionics and vetronics network. Further, the analytics and ML algorithms may comprise at least one of a predictive analytics model, isolation forest, one-class SVM model, linear regression, polynomial regression, autoregressive integrated moving average (ARIMA) and long short-term memory (LSTM), decision trees, random forests, neural networks, K-means, etc.

Further, the condition-based maintenance model 204 may be configured to analyze and assess a current health and performance of the one or more components of the avionics and vetronics network. Further, the analytics and ML algorithms may facilitate the condition-based maintenance model 204 to detect early signs of wear and tear, degradation, or potential failures in the one or more components of the avionics and vetronics network. Further, the condition-based maintenance model 204 may be configured to utilize a normal data and trend analysis to determine normal operational patterns of the one or more components of the avionics and vetronics network. Further, the condition-based maintenance model 204 may be configured to identify deviations in the data from the normal operational patterns. Further, by identifying the deviations from the normal operational patterns, the condition-based maintenance model 204 may facilitate the at least one processor to determine the one or more anomalies from monitored data of the one or more components.

In some embodiments, the condition-based maintenance model 204 may comprise a diagnostics reasoner 214, a system model 216, and an anomaly detection 218. In some embodiments, the diagnostic reasoner 214 may be coupled with the one or more components of the system model 216 “i.e., the avionics and vetronics network”. Further, the diagnostic reasoner 214 may be configured to receive and interpret data from the one or more components of the system model 216 to determine a health status of the one or more components. In some embodiments, the anomaly detection 218 may facilitate the at least one processor 200 to analyze patterns of the data received from the diagnostics reasoner 214. Further, the anomaly detection 218 may facilitate the at least one processor 200 to detect the one or more anomalies within the one or more components of the system model 216 using one or more deviations in the analyzed patterns of the data received from the diagnostic reasoner 214.

In some embodiments, the cyber-defense model 206 may be configured to provide cybersecurity to address potential threats and vulnerabilities within the avionics and vetronics network. The cyber-defense model 206 may be configured to monitor integrity and security of one or more communication channels, data streams, and hardware components of the avionics and vetronics network to detect the one or more anomalies within the avionics and vetronics network. Further, the one or more anomalies detected by the cyber-defense model 206 may indicate cyberattacks or malicious activities within the avionics and vetronics network. Further, the cyber-defense model 206 may be configured to employ one or more techniques to identify the one or more anomalies. Further, the one or more techniques may comprise at least one of an intrusion detection system, anomaly detection algorithms, and real time threat intelligence.

In some embodiments, the cyber-defense model 206 may comprise a virus detection 220, an intrusion detection 222, and an anomaly detection 218. In some embodiments, the virus detection 220 may be configured to identify malware in communication network of the one or more components of the avionics and vetronics network. In some embodiments, the virus detection 220 may utilize one or more techniques such as signature-based detection technique, heuristic analysis, and sandboxing to detect the malware in the communication network of the one or more components of the avionics and vetronics network. Further, the intrusion detection 222 may be configured to monitor network traffic in one or more communication channels associated with the avionics and vetronics network. Further, the intrusion detection 222 may comprise at least one of a network-based intrusion detection system (NIDS) and host-based intrusion detection system (HIDS). In some embodiments, the anomaly detection 218 may facilitate the at least one processor 200 to identify the patterns that may indicate the evidence of the cyberattack within the avionics and vetronics network.

In some embodiments, the at least one processor 200 may be configured to determine whether the one or more anomalies is related to the cascading fault using the condition-based maintenance model 204 and the cyber-defense model 206. In some embodiments, the cascading fault may correspond to a sequence of failures of the one or more components within the avionics and vetronics network where an initial failure of one component of the one or more components triggers subsequent failures in other components of the one or more components. Further, the sequence of failures may lead to a chain reaction that may significantly impact operations of the avionics and vetronics network. In some embodiments, the one or more components of the avionics network 104 and the one or more components of the vetronics network 106 may rely on each other for data, power, and operational support. In one scenario, when one component of the one or more components fails, the other dependent components may also experience failures.

In one example, if the flight control module in the avionics network 104 experiences a failure, it may affect the navigation module of the avionics network 104 that is dependent upon the flight control module. In another example, if the engine monitoring module of the vetronics network 106 experiences a failure it may affect the safety and alerting module of the vetronics network 106 that may be dependent upon the engine monitoring module.

In some embodiments, the at least one processor 200 may be configured to determine the one or more anomalies may correspond to the component failure within the avionics and vetronics network upon determining the one or more anomalies may relate to the cascading fault. In some embodiments, the component failure within the avionics and vetronics network may correspond to an abnormal behavior or breakdown of the one or more components within the avionics and vetronics network. For example, the surveillance and monitoring module may depend upon the communication module. Further, when the communication module experiences a failure, it may affect the surveillance and monitoring module. Herein, the at least one processor 200 may determine the component failure as the cascading fault.

In some embodiments, the at least one processor 200 may be configured to determine the one or more anomalies may correspond to the evidence of the cyberattack within the avionics and vetronics network upon determining the one or more anomalies are not related to the cascading fault. In some embodiments, the evidence of the cyberattack may correspond to interference, disruption, malfunction, or compromise of the one or more components caused by cyber threats. Further, the cyber threats may include, but are not limited to, hacking, malware, or other forms of cyberattacks. For example, the safety and alerting module may depend upon the engine monitoring module as the safety and alerting module may be configured to provide alerts to the user when the engine monitoring module detects any failure in the aircraft's engine. Further, if the engine monitoring module experiences a failure, and it may not affect the safety and alerting module, the one or more anomalies may not relate to the cascading fault. Herein, the at least one processor 200 may determine the evidence of the cyberattack as the one or more anomalies may not relate to the cascading fault.

In some embodiments, the at least one processor 200 may be configured to generate one or more alerts for the user associated with the one or more anomalies, upon determining that the one or more anomalies may correspond to the component failure or evidence of the cyberattack. In some embodiments, the at least one processor 200 may be configured to display the one or more alerts to the user, for taking an appropriate action in response to the one or more anomalies determined within the avionics and vetronics network. Further, the one or more alerts may comprise at least one of visual alerts, auditory alerts, textual alerts, tactile alerts, or remote alerts.

In some embodiments, the server 108 may be communicatively coupled with a display unit 208. Further, the display unit 208 may be configured to display the one or more alerts to the user, for taking the appropriate action in response to the one or more anomalies determined within the avionics and vetronics network. In some embodiments, the display unit 208 may be installed with a graphical user interface (GUI). In some embodiments, the GUI of the display unit 208 may be configured to visually and audibly notifies the user of the one or more alerts such as visual alerts, auditory alerts, textual alerts, textual alerts, tactile alerts, or remote alerts.

In some embodiments, the memory 202 may be configured to store a set of instructions and data executed by the at least one processor 200. Further, the memory 202 may include the one or more instructions that are executable by the at least one processor 200 to perform specific operations. The memory 202 may be configured to include the instructions to monitor data of the one or more components within the avionics and vetronics network in real time. The memory 202 may be configured to include the instructions to determine the one or more anomalies from the monitored data using the condition-based maintenance model 204 and the cyber-defense model 206. Further, the memory 202 may be configured to include the instructions to determine whether the one or more anomalies is related to the cascading fault using the condition-based maintenance model 204 and the cyber-defense model 206.

The memory 202 may be configured to include the instructions to determine the one or more anomalies corresponding to the component failure within the avionics and vetronics network upon determining the one or more anomalies are related to the cascading fault or the one or more anomalies corresponding to the evidence of the cyberattack within the avionics and vetronics network upon determining the one or more anomalies are not related to the cascading fault. Thereafter, the memory 202 may be configured to include the instructions to generate the one or more alerts for the user associated with the one or more anomalies, upon determining that the one or more anomalies correspond to the component failure or evidence of the cyberattack.

The memory 202 may be configured to store the monitored data of the one or more components of the avionics and vetronics network. It is apparent to a person with ordinary skill in the art that the one or more instructions stored in the memory 202 enable the hardware of the system 100 to perform the predetermined operations. Some of the commonly known memory implementations include, but are not limited to, fixed (hard) drives, magnetic tape, floppy diskettes, optical disks, Compact Disc Read-Only Memories (CD-ROMs), and magneto-optical disks, semiconductor memories, such as ROMs, Random Access Memories (RAMs), Programmable Read-Only Memories (PROMs), Erasable PROMs (EPROMs), Electrically Erasable PROMs (EEPROMs), flash memory, magnetic or optical cards, or other type of media/machine-readable medium suitable for storing electronic instructions.

In some embodiments, the server 106 may further comprise the input/output circuitry 210. The input/output circuitry 210 may enable the user to communicate or interface with the system 100, via the user device 110. The user device 110 may include N number of user devices. In some embodiments, the input/output circuitry 210 may act as a medium to transmit input from the interface to and from the server 106. In some embodiments, the input/output circuitry 210 may refer to the hardware and software components that facilitate the exchange of information between the user device 110 and the server 106. In one example, the system 100 may include the user interface as an input circuitry that facilitates monitoring of the data of the one or more components of the avionics and vetronics network. The input/output circuitry 210 may include various input devices such as the flight control module, the navigation module, the communication module, the surveillance and monitoring module, the weather module, the safety and alerting module, and the engine monitoring module and various output devices such as the display unit 208, printers for the one or more users to receive data. In another example, the input/output circuitry 210 may include various output circuitry such as the display unit 208.

In some embodiments, the server 106 may further comprise the communication circuitry 212. The communication circuitry 212 may allow the server to exchange data or information with the user device 110, other systems or apparatuses. Further, the communication circuitry 212 may include network interfaces, protocols, and software modules responsible for sending and receiving data or information from the user device 110. In some embodiments, the communication circuitry 212 may include Ethernet ports, Wi-Fi adapters, or communication protocols like HTTP or MQTT for connecting with other systems. The communication circuitry 212 may further include components such as communication modules (e.g., Wi-Fi, Ethernet, cellular), transceivers, antennas, and protocols (e.g., TCP/IP, MQTT, SNMP) for exchanging data with the user device 110 and the other systems. The communication circuitry 212 may allow the server 108 to stay up-to-date.

As illustrated in FIG. 2B, the cyber physical system architecture may comprise the one or more components such as sensors 224, controllers 226, and actuators 228. In some embodiments, the sensors 224 may be 1 to N, the controllers 226 may be 1 to N, and the actuators 228 may be 1 to N. In some embodiments, the sensors 224 may be configured to monitor one or more parameters such as temperature, pressure, and moisture. In some embodiments, the controllers 226 may be configured to receive one or more parameters from the sensors 224. Further, the controllers 226 may be configured to control operations of the actuators 228 based at least on the one or more parameters.

In some embodiments, each of the sensors 224 and actuators 228 may be either directly connected to the controller 226 or connected indirectly through a data bus 230. Further, the data bus 230 may be of a range from 1 to n. In some embodiments, the data bus 230 may be configured to facilitate a data transfer between the one or more components of the avionics and vetronics network and the condition-based maintenance model 204 and the cyber-defense model 206. Further, upon detection of the component failure or the evidence of the cyberattack, the at least one processor 200 may be configured to display the one or more alerts to the user. Further, the status to user 232 may facilitate the at least one processor 200 to provide the one or more alerts to the user through the display unit 208. Further, based at least on the one or more alerts, the user may be configured to control operations of the component of the one or more components that may experience failure. The user inputs 234 may facilitate the user to provide one or more inputs to control operations of the component. In one example, when the at least one processor 200 determines a component failure in the aircraft's autopilot, the user may provide an input through the user inputs 234 to take manual control of the aircraft.

It will be apparent to one skilled in the art the above-mentioned components of the server 108 have been provided only for illustration purposes, without departing from the scope of the disclosure.

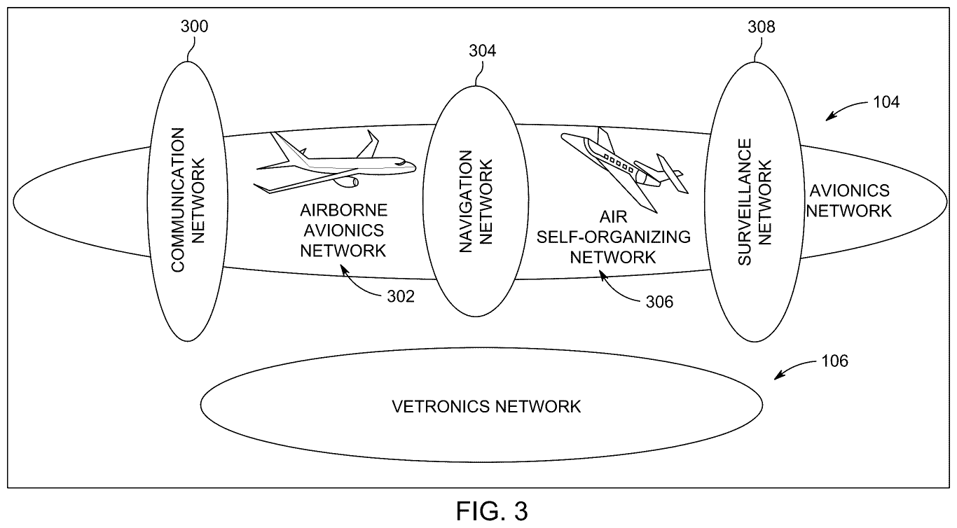

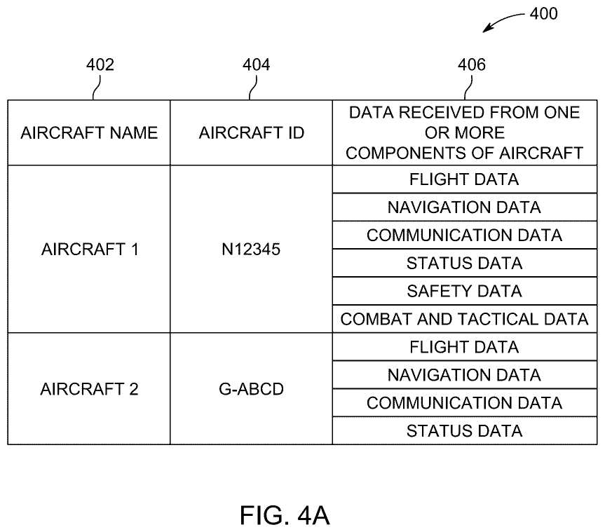

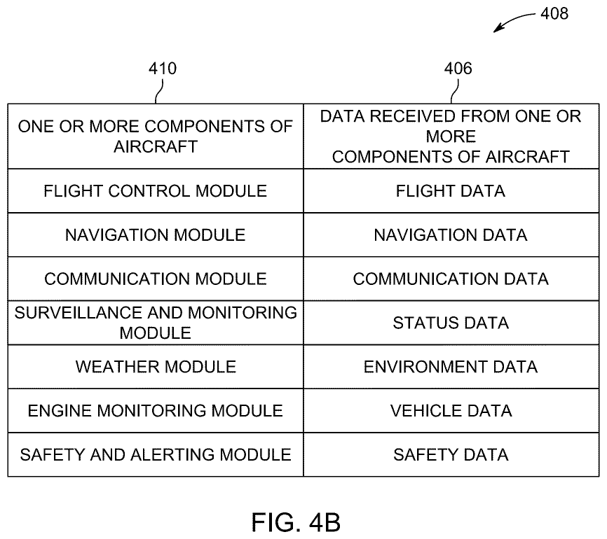

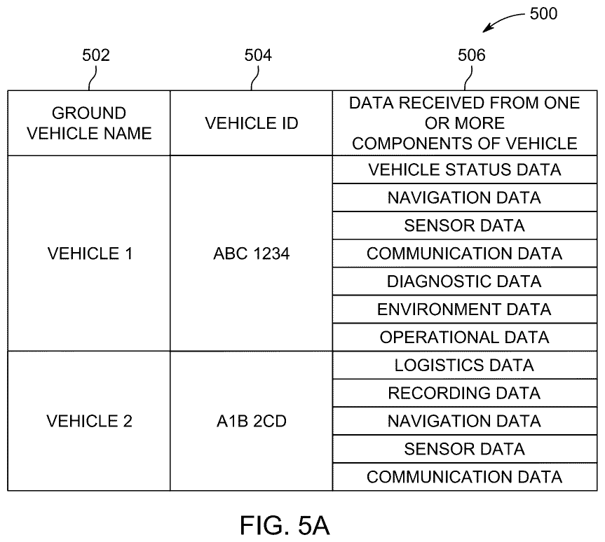

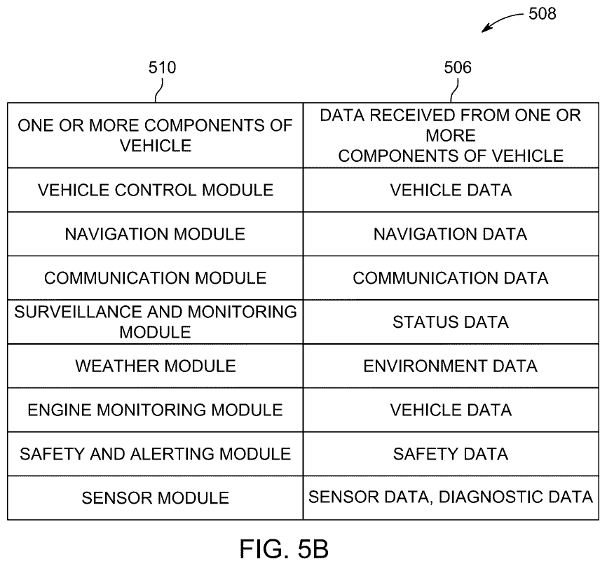

FIG. 3 illustrates a communication architecture of the avionics network 104 and vetronics network 106, in accordance with an example embodiment of the present disclosure. FIGS. 4A-4B illustrate tables 400, 408 having data associated with the avionics network 104, in accordance with an example embodiment of the present disclosure. FIGS. 5A-5B illustrate tables 500, 508 having data associated with the vetronics network 106, in accordance with an example embodiment of the present disclosure. FIGS. 3-5B are described in conjunction with FIGS. 1-2.

In some embodiments, the avionics network 104 may comprise one or more sub-networks. Further, the one or more sub-networks may comprise a communication network 300, airborne avionics network 302, navigation network 304, air self-organizing network 306, and a surveillance network 308. In some embodiments, the communication network 300 may facilitate a transfer of data between the avionics network 104 and other external systems. In some embodiments, the communication network 300 may comprise one or more communication protocols. Further, the one or more communication protocols may comprise wired communication protocols, and a wireless communication protocols. In some embodiments, the communication network 300 may include, but is not limited to, data links for voice communication, data communication, video communication, integrating technologies such as very high frequency (VFH), satellite communication (SATCOM), and controller-pilot data ink communication (CPDLC). In one example, the communication network 300 may be configured to enable communication between the aircraft and one or more ground control stations.

In some embodiments, the airborne avionics network 302 may be configured to enable an internal communication within the aircraft. Further, the airborne avionics network 302 may be configured to interconnect various avionics systems within the aircraft including the flight control systems, navigation systems, weather radar, and collision avoidance systems. The airborne avionics network 302 may be configured to ensure a real time data exchange between the various avionics systems within the aircraft. In one example, the airborne avionics network 302 may correspond to a wired communication that may utilize one or more high-speed data buses. For example, the one or more high-speed data buses may comprise at least one of a ARINC 429, ARINC 664 (AFDX), and MIL-STD-1553.

In some embodiments, the navigation network 304 may encompass acquisition, processing, and distribution of a navigational data Further, the navigation network 304 may be integrated into various applications such as global positioning system (GPS), inertial navigation system (INS), distance measuring equipment (DME), and automatic direction finder (ADF). In some embodiments, the navigation network 304 may be configured to provide an accurate and reliable positional data to the flight management system (FMS) and other avionics systems. Further, the navigation network 304 may be configured to enable a precise route planning, flight path management, and situational awareness.

In some embodiments, the air self-organizing network 306 may be configured to manage network topology and resource allocation within an airborne environment of the aircraft. In some embodiments, the sir self-organizing network 306 may utilize leverages principles of self-organization and adaptive networking to optimize communication pathways and data flow, based at least on one or more operational conditions of the aircraft. As illustrates in FIG. 3, the surveillance network 308 may be configured to monitor and report position of the aircraft, movement, and other parameters. Further, the surveillance network 308 may comprise at least one of automatic dependent surveillance-broadcast (ADS-B), secondary surveillance radar (SSR), traffic collision avoidance system (TCAS), and mode S transponders. In some embodiments, the surveillance network 308 may be configured to provide a real time situational awareness to the flight crew and air traffic controllers, that may enhance safety and coordination of air traffic.

In some embodiments, the system 100 may be integrated with the avionics network 104 having one or more aircrafts (as illustrated in FIG. 3). Further, the table 400 may comprise one or more columns comprising aircraft name 402, aircraft ID 404, and data received from one or more components of aircraft (illustrated by 406 in FIG. 4A). Further, the one or more aircrafts may comprise an aircraft-1 and an aircraft-2. Further, each of the one or more aircrafts may be provided with a unique identification number. The aircraft-1 has the unique identification number e.g., “N12345” and the aircraft-2 has the unique identification number e.g., “G-ABCD”. Further, each of the one or more aircrafts may provide data to a ground station. In some embodiments, the at least one processor 200 of the server 108 may be configured to monitor the data. As illustrated in FIG. 4A, the data provided by the one or more components of the aircraft-1 may comprise the flight data, the navigation data, the communication data, the status data, the safety data, and the combat and tactical data. Further, the data provided by the one or more components of the aircraft-2 may comprise the flight data, the navigation data, the communication data, and the status data.

As illustrated in FIG. 4B, each of the one or more components of the aircraft may be configured to provide a corresponding data. Further, the table 408 may comprise one or more columns i.e., one or more components of aircraft (illustrated by 410) and data received from one or more components of aircraft 406. Further, the one or more components may comprise the flight control module, the navigation module, the communication module, the surveillance and monitoring module, the weather module, the engine monitoring module, and the safety and alerting module. In some embodiments, each of the one or more components may be configured to provide the corresponding data. Further, the flight control module may be configured to provide the flight data, and the navigation module may be configured to provide the navigation data. Further, the communication module may be configured to provide the communication data, and the surveillance and monitoring module may be configured to provide the status data. Further, the weather module may be configured to provide the environment data, the engine monitoring module may be configured to provide the vehicle data, and the safety and alerting module may be configured to provide the safety data.

In some embodiments, the system 100 may be integrated with the vetronics network 106 having one or more vehicles (as illustrated in FIG. 3). Further, the table 500 may comprise one or more columns i.e., a ground vehicle name 502, vehicle ID 504, and data received from one or more components of vehicle (illustrated by 506 in FIG. 5A). Further, the one or more vehicles may comprise a vehicle-1 and a vehicle-2. Further, each of the one or more vehicles may be provided with a unique identification number. The vehicle-1 has the unique identification number e.g., “ABC 1234” and the vehicle-2 has the unique identification number e.g., “AIB 2CD”. Further, each of the one or more vehicles may provide data to a command station. In some embodiments, the at least one processor 200 of the server 108 may be configured to monitor the data. As illustrated in FIG. 5A, the data provided by the one or more components of the vehicle-1 may comprise the vehicle status data, the navigation data, the sensor data, the communication data, the diagnostic data, the environment data, and the operational data. Further, the data provided by the one or more components of the vehicle-2 may comprise the logistics data, recording data, navigation data, sensor data, and communication data.

As illustrated in FIG. 5B, each of the one or more components of the one or more vehicles may be configured to provide a corresponding data. Further, the table 508 may comprise one or more columns i.e., one or more components of vehicle (illustrated by 510) and data received from one or more components of vehicle (illustrated by 506). Further, the one or more components may comprise the vehicle control module, the navigation module, the communication module, the surveillance and monitoring module, the weather module, the engine monitoring module, the safety and alerting module, and the sensor module. In some embodiments, each of the one or more components may be configured to provide the corresponding data. Further, the flight control module may be configured to provide the vehicle data, and the navigation module may be configured to provide the navigation data. Further, the communication module may be configured to provide the communication data, and the surveillance and monitoring module may be configured to provide the status data. Further, the weather module may be configured to provide the environment data, the engine monitoring module may be configured to provide the vehicle data, and the safety and alerting module may be configured to provide the safety data. Further, the sensor module may be configured to provide the sensor data, diagnostic data.

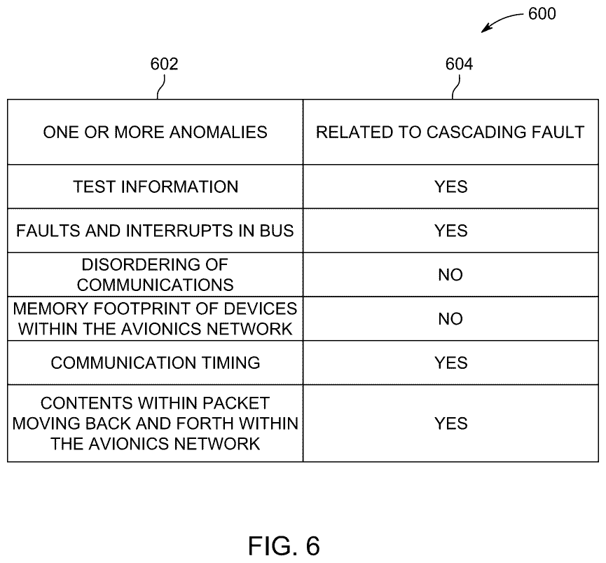

FIG. 6 illustrates a table 600 showing the one or more anomalies determined by the system 100 within the avionics and vetronics network, in accordance with an example embodiment of the present disclosure. FIG. 6 is described in conjunction with FIGS. 3-5B.

In some embodiments, the at least one processor 200 of the server 108 may be configured to determine the one or more anomalies from the monitored data using the condition-based maintenance model 204 and the cyber-defense model 206. In some embodiments, the table 600 may comprise one or more columns that include the one or more anomalies 602 and related to cascading fault 604. In some embodiments, the at least one processor 200 may be configured to detect the one or more anomalies 602 within the avionics network 104 and the vetronics network 106. The one or more anomalies 602 may include, but are not limited to, test information, faults and interrupts in bus, disordering of communications, memory footprint of devices within the avionics network 104, communication timing, and contents within packet moving back and forth within the avionics network 104. Further, the at least one processor 200 may be configured to determine whether the one or more anomalies 604 is related to the cascading fault using the condition-based maintenance model 204 and the cyber-defense model 206.

As illustrated in FIG. 6, the column “related to cascading fault 604” may be configured to provide data associated with results of determining the one or more anomalies 604 corresponding to the components failure within the avionics and vetronics network. Further, the at least one processor 200 may determine that the test information may relate to the cascading fault denoted as “YES”. Further, the at least one processor 200 may determine that the faults and interrupts in bus may relate to the cascading fault denoted as “YES”. Further, the at least one processor 200 may determine that the disordering of communications may not relate to the cascading fault denoted as “NO”. Further, the at least one processor 200 may determine the memory footprint of devices within the avionics network 104 may not relate to the cascading fault denoted as “NO”. Further, the at least one processor 200 may determine that the communication timing may relate to the cascading fault denoted as “YES”. Further, the at least one processor 200 may determine that the contents within packet moving back and forth within the avionics network 104 may relate to the cascading fault denoted as “YES”.

In some embodiments, based at least on the determination of the cascading fault as shown by the table 600, the at least one processor 200 may be configured to determine the one or more anomalies 602 may correspond to the component failure or the evidence of the cyberattack within the avionics and vetronics network. In some embodiments, based at least on the determination of the cascading fault as shown by the table 600, the at least one processor 200 may determine the one or more anomalies 602 may correspond to the component failure. Further, the one or more anomalies 602 may comprise the test information, the faults and interrupts in bus, the communication timing, and the contents within the packet moving back and forth within the avionics network 104. Further, the at least one processor 200 may determine the one or more anomalies “the disordering of communication, and the memory footprint of devices within the avionics network 104” may correspond the evidence of the cyberattack.

In some embodiments, the at least one processor 200 may be configured to generate the one or more alerts for the user associated with the one or more anomalies, upon determining the one or more anomalies may correspond to the component failure or evidence of the cyberattack. Further, the at least one processor 200 may be configured to display the one or more alerts to the user on the display unit 208 of the system 100. Further, the user may take the appropriate action in response to the one or more alerts provided on the display unit 208. In one example, the appropriate action may correspond to alerting the ground station regarding the one or more alerts.

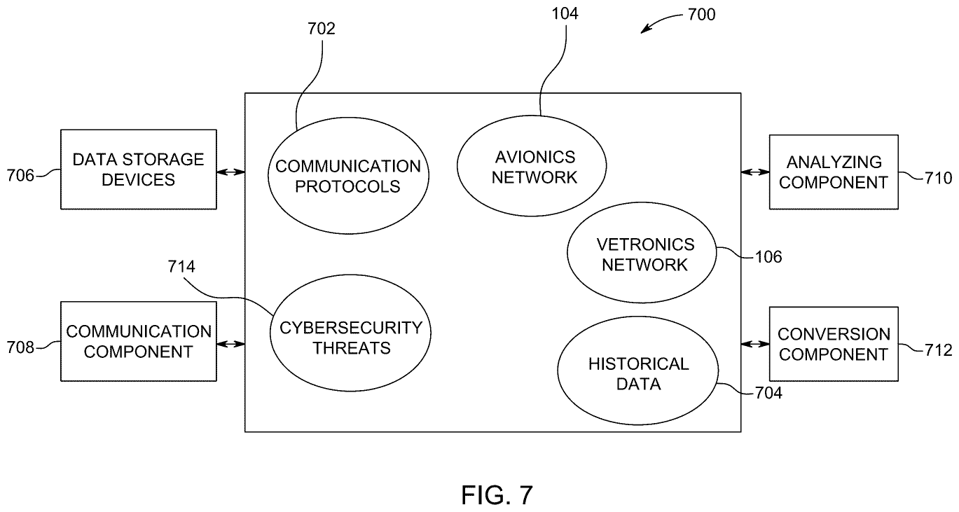

FIG. 7 illustrates a block diagram 700 showing communication among various components within the avionics and vetronics network, in accordance with an example embodiment of the present disclosure.

In some embodiments, a plurality of communication protocols 702 may be configured to enable a reliable and real time data transmission with the server 108. In some embodiments, the plurality of communication protocols 702 may include, but are not limited to, ARINC 429, MIL-STD-1553, ARINC 664, CAN Bus, and time-triggered protocol (TTP). In some embodiments, the normal data (as illustrated in FIG. 2A) may correspond to a historical data 704. Further, the historical data 704 may be configured to store the data using the one or more data storage and management techniques such as neural networks technique or blockchain technique.

In some embodiments, the at least one processor 200 may be configured to monitor the data of the one or more components within the avionics and vetronics network in the real time. Further, the at least one processor 200 may be configured to compare the monitored data of the one or more components with the historical data 704. In some embodiments, the at least one processor 200 may be configured to determine the one or more anomalies, based at least on the comparison of the monitored data and the historical data 704 and using the condition-based maintenance model 204 and the cyber-defense model 206. In some embodiments, the one or more components may correspond to data storage devices 706, communication component 708, analyzing component 710, and a conversion component 712, as illustrated in the block diagram 700. In some embodiments, the data storage devices 706 may be configured to facilitate the at least one processor 200 to store the historical data 704. Further, the data storage devices 706 may comprise at least one of a HDDs (hard-disk drives), SDDs (solid state drives), or NAS (network attached storage).

In some embodiments, the communication component 708 may be configured to facilitate the at least one processor 200 to transfer data to the server 108. Further, the communication component 708 may comprise one or more network interfaces such as Ethernet ports, wireless adapters, etc., and the one or more communication protocols such as TCP/IP, ARINC 429, MIL-STD-1553, AFDX, etc. In some embodiments, the analyzing component 710 may be configured to process and interpret the historical data 704. In some embodiments, the analyzing component 710 may comprise one or more data analysis tools such as statistical analysis, machine learning (ML) algorithms, data mining, etc., and one or more real time analytics. In some embodiments, the conversion component 712 may be configured to transform one format of data into another format. Further, the conversion component 712 may comprise data formatting, data encoding/decoding, and protocol translation. For example, the navigation module may be configured to provide the data in a form of digital signals. Further, the conversion component 712 may be configured to convert the digital signals into an encrypted line of code.

In some embodiments, one or more cybersecurity threats 714 of the avionics network 104 may comprise malware attacks, data interception and eavesdropping, denial of service (DoS) attacks, GPS spoofing, and unauthorized access. Further, the one or more cybersecurity threats 714 of the vetronics network 106 may comprise CAN bus attacks, jamming and interference, remote exploitation, ransomware attacks, and firmware tampering. It will be apparent to one skilled in the art that above-mentioned components of the block diagram 700 have been provided only for illustration purposes, without departing from the scope of the disclosure.

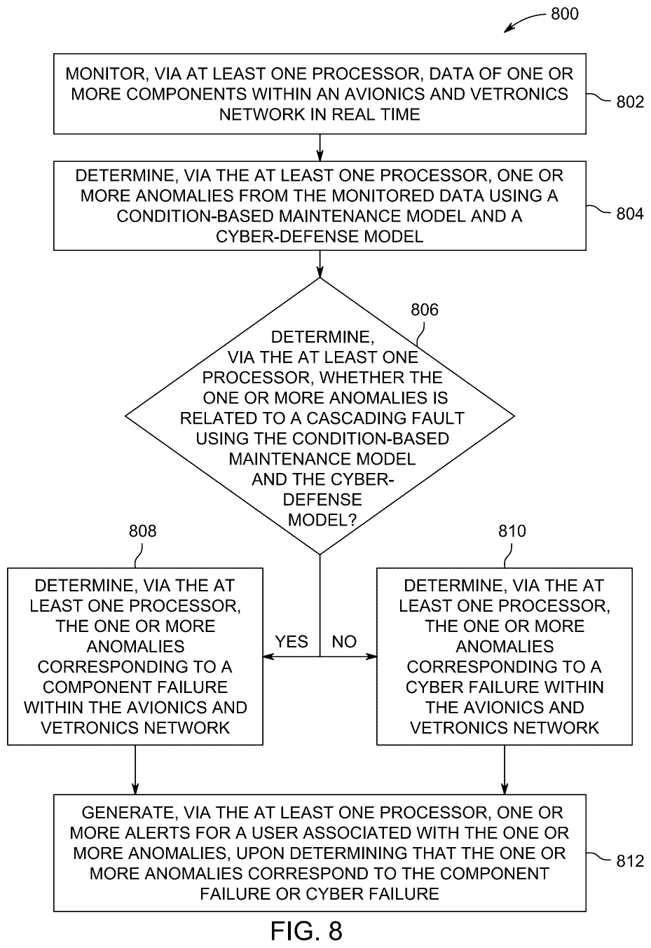

FIG. 8 illustrates a flowchart showing a method 800 for detecting anomalies within an avionics and vetronics network, in accordance with an example embodiment of the present disclosure. FIG. 8 is described in conjunction with FIGS. 1-7.

At operation 802, the at least one processor 200 may be configured to monitor the data of the one or more components within the avionics and vetronics network in real time. Further, the data may comprise at least one of the flight data, vehicle data, navigation data, communication data, status data, safety data, and combat and tactical data. Further, the one or more components within the avionics and vetronics network may comprise at least one of the flight control module, navigation module, communication module, surveillance and monitoring module, weather module, safety and alerting module, and engine monitoring module.

In one example, the system 100 is communicatively coupled to an avionics network 104 of an aircraft. Further, the aircraft may comprise at least one of a passenger aircraft, a cargo aircraft, a commercial airliner, helicopter, fighter jet, and unmanned aerial vehicle (UAV). Further, the system 100 is configured to run for a schedule and mandatory check of anomalies within the avionics network 104 for the aircraft. Further, the system 100 monitors data from a flight control module, navigation module, and communication module of the aircraft. Further, the data comprises a flight data, vehicle data, navigation data, communication data, and status data.

In another example, the system 100 is communicatively coupled to the vetronics network 106 of a battle tank. Further, the system 100 is configured to run on a schedule and perform mandatory checks for anomalies within the vetronics network 106 of the vehicle. Further, the at least one processor 200 of the server 108 monitors data from the fire control module, navigation module, and communication module of the tank. Further, the data comprises fire control data, vehicle performance data, navigation data, communication data, and system status data.

At operation 804, the at least one processor 200 may be configured to determine the one or more anomalies from the monitored data using the condition-based maintenance model 204 and the cyber-defense model 206. Further, the condition-based maintenance model 204 and the cyber-defense model 206 may be configured to determine unexpected behaviors in the data representing component failure and evidence of the cyberattack respectively, within the avionics and vetronics network. Further, the condition-based maintenance model 204 may be configured to use analytics and machine learning (ML) algorithms to assess the current state and performance of each component of the one or more components of the avionics and vetronics network. In some embodiments, the cyber-defense model 206 may be configured to provide cybersecurity to address potential threats and vulnerabilities within the avionics and vetronics network.

In one example, the at least one processor 200 is configured to determine one or more anomalies within the avionics network 104 from the monitored data using a condition-based maintenance model 204 and a cyber-defense model 206. Further, the one or more anomalies are detected in the navigation data and the flight data of the aircraft. Further, the at least one processor 200 is configured to compare the monitored data with a historical data 704. Further, the at least one processor 200 is configured to determine the one or more anomalies from the monitored data, based at least on the comparison using the condition-based maintenance model 204 and the cyber-defense model 206.

In another example, the at least one processor 200 is configured to determine one or more anomalies within the vetronics network 106 from the monitored data using the condition-based maintenance model 204 and the cyber-defense model 206. Further, the one or more anomalies are detected in the navigation data and the vehicle performance data of the tank. Further, the at least one processor 200 is configured to compare the monitored data with the historical data 704. Further, the at least one processor 200 is configured to determine the one or more anomalies from the monitored data based at least on the comparison using the condition-based maintenance model 204 and the cyber-defense model 206.

At operation 806, the at least one processor 200 may be configured to determine whether the one or more anomalies are related to the cascading fault using the condition-based maintenance model 204 and the cyber-defense model 206. Further, the cascading fault may correspond to the sequence of failures of the one or more components within the avionics and vetronics network. In some embodiments, the sequence of failures of the one or more components where an initial failure of one component of the one or more components triggers subsequent failures in other components of the one or more components. Further, the sequence of failures may lead to a chain reaction that may significantly impact operations of the avionics and vetronics network.

In one example, upon detecting the one or more anomalies, the at least one processor 200 determines that the flight data shows a cascading fault related to an electrical bus in the aircraft's electrical system fails due to a short circuit. The failure of the electrical bus causes an immediate loss of power to Primary Flight Display (PFD), Autopilot System, Navigation System and Communication Radios. Without the PFD, the controller lose their primary source of flight data, including attitude, altitude, and airspeed information. The loss of the autopilot system requires the controller to take manual control of the aircraft, increasing their workload significantly. Navigation system failure means the aircraft can no longer follow the programmed flight path accurately. Communication radio failure hinders the ability to communicate with Air Traffic Control (ATC) and other aircraft.

In another example, upon detecting the one or more anomalies, the at least one processor 200 determines that the vehicle performance data shows a cascading fault related to an electrical bus in the tank's electrical system failing due to a short circuit. The failure of the electrical bus causes an immediate loss of power to the Fire Control System (FCS), Navigation System, Communication Radios, and Vehicle Health Monitoring System (VHMS). Without the FCS, the tank loses its ability to accurately target and engage threats. The loss of the navigation system means the tank can no longer follow pre-programmed routes or coordinate movements with other units, leading to potential operational delays and navigational errors. The failure of communication radios hinders the crew's ability to communicate with command and other units, disrupting tactical coordination and situational awareness. Further, without the VHMS, the crew can no longer monitor the vehicle's health status, making it difficult to detect and address other potential issues in real time.

At operation 808, the at least one processor 200 may be configured to determine the one or more anomalies may correspond to the component failure within the avionics and vetronics network upon determining the one or more anomalies are related to the cascading fault. In some embodiments, the component failure within the avionics and vetronics network may correspond to an abnormal behavior or breakdown of the one or more components within the avionics and vetronics network. In some embodiments, the evidence of the cyberattack may correspond to interference, disruption, malfunction, or compromise of the one or more components caused by cyber threats. Further, the cyber threats may include, but are not limited to, hacking, malware, or other forms of cyberattacks.

In one example, when the failure of the electrical bus causes an immediate loss of power to the Fire Control System (FCS), Navigation System, Communication Radios, and Vehicle Health Monitoring System (VHMS), the at least one processor 200 determines the cascading fault. Further, the at least one processor 200 is configured to determine a component failure upon determining the one or more anomalies are related to the cascading fault.

At operation 810, the at least one processor 200 may be configured to determine the one or more anomalies corresponding to the evidence of the cyberattack within the avionics and vetronics network upon determining the one or more anomalies are not related to the cascading fault. In some embodiments, the evidence of the cyberattack may correspond to interference, disruption, malfunction, or compromise of the one or more components caused by cyber threats. Further, the cyber threats may include, but are not limited to, hacking, malware, or other forms of cyberattacks.

In one example, upon detecting the one or more anomalies, the at least one processor 200 determines that the flight data the cascading fault is not determined. Further, the one or more anomalies relates to a cyberattack on the aircraft's avionics network. The cyberattack involves malicious software infiltrating the network, leading to the compromise of critical systems. The attack causes an immediate disruption of the Primary Flight Display (PFD), Autopilot System, Navigation System, and Communication Radios. Without the PFD, a controller lose their primary source of flight data, including attitude, altitude, and airspeed information. The loss of the autopilot system requires the controller to take manual control of the aircraft, significantly increasing their workload. Navigation system compromise means the aircraft can no longer follow the programmed flight path accurately, posing a risk of deviation from the intended route. The failure of the communication radios hinders the ability to communicate with Air Traffic Control (ATC) and other aircraft, creating a potential safety hazard and coordination issue.

In another example, upon detecting the one or more anomalies does not indicate a cascading fault. The at least one processor 200 determines that the one or more anomalies relates to a cyberattack on the tank's vetronics network. The cyberattack involves malicious software infiltrating the network, leading to the compromise of critical systems. The attack causes an immediate disruption of the Fire Control System (FCS), Navigation System, Communication Radios, and Vehicle Health Monitoring System (VHMS). Without the FCS, the tank loses its ability to accurately target and engage threats, significantly reducing its combat effectiveness. The compromise of the navigation system means the tank can no longer follow pre-programmed routes or coordinate movements with other units, increasing the risk of navigational errors and operational delays. The failure of communication radios hinders the crew's ability to communicate with command and other units, disrupting tactical coordination and situational awareness. Further, without the VHMS, the crew is unable to monitor the vehicle's health status, making it difficult to detect and address other potential issues in real time, further jeopardizing mission success and crew safety.

At operation 812, the at least one processor 200 may be configured to generate one or more alerts for a user associated with the one or more anomalies, upon determining that the one or more anomalies correspond to the component failure or evidence of the cyberattack. In some embodiments, the at least one processor 200 may be configured to display the one or more alerts to the user, for taking an appropriate action in response to the one or more anomalies determined within the avionics and vetronics network. Further, the one or more alerts may comprise at least one of visual alerts, auditory alerts, textual alerts, tactile alerts, or remote alerts. In some embodiments, the system 100 may comprise the display unit 208. Further, the display unit 208 may be configured to display the one or more alerts to the user, for taking the appropriate action in response to the one or more anomalies determined within the avionics and vetronics network.

In one example, based on the one or more anomalies, the system 100 is configured to generate visual alerts, auditory alerts, textual alerts, tactile alerts, or remote alerts. Based on the alerts, user can take action regarding Informing ATC about the situation, including any loss of communication or navigation capabilities, to receive assistance and priority handling if needed. Further, assess the feasibility of continuing the flight versus diverting to the nearest suitable airport based on the severity of the electrical failure, weather conditions, and available facilities.

In another example, based on the one or more anomalies, the at least one processor 200 is configured to generate visual alerts, auditory alerts, textual alerts, tactile alerts, or remote alerts. Based on the alerts, the crew takes action regarding informing the command center about the situation, including any loss of communication or navigation capabilities, to receive assistance and priority handling if needed. Additionally, the crew should assess the feasibility of continuing the mission versus retreating to a safe location based on the severity of the system failures, battlefield conditions, and available support. Further, the crew initiates contingency procedures, such as switching to backup systems or implementing manual overrides, to maintain operational effectiveness and ensure the safety of the personnel and the vehicle.

In some embodiments, a non-transitory machine-readable information storage medium is disclosed. The non-transitory machine-readable information storage medium may comprise one or more instructions which when executed by at least one processor 200 cause the at least one processor 200 to monitor data of one or more components within an avionics and vetronics network in real time. The data comprises at least one of flight data, vehicle data, navigation data, communication data, status data, safety data, and combat and tactical data associated with the avionics and vetronics network. The one or more components of the avionics and vetronics network comprises at least one of a flight control module, a navigation module, a communication module, a surveillance and monitoring module, a weather module, a safety and alerting module, and an engine monitoring module. Further, the non-transitory machine-readable information storage medium may comprise one or more instructions which when executed by the at least one processor 200 cause the at least one processor to determine one or more anomalies from the monitored data using a condition-based maintenance model 204 and a cyber-defense model 206.

Further, the condition-based maintenance model 204 and the cyber-defense model 206 are configured to determine unexpected behaviors in the data representing component failure and evidence of the cyberattack respectively, within the avionics and vetronics network. The one or more anomalies correspond to at least one of test information, faults and interrupts in bus, disordering of communications, memory footprint of devices within the avionics network 104, communication timing, contents within packet moving back and forth within the avionics and vetronics network.

Further, the non-transitory machine-readable information storage medium may comprise one or more instructions which when executed by the at least one processor 200 cause the at least one processor 200 to determine whether the one or more anomalies is related to a cascading fault using the condition-based maintenance model 204 and the cyber-defense model 206. The cascading fault corresponds to a sequence of failures of the one or more components within the avionics and vetronics network. Further, the non-transitory machine-readable information storage medium may comprise one or more instructions which when executed by the at least one processor 200 cause the at least one processor 200 to determine the one or more anomalies corresponding to a component failure within the avionics and vetronics network upon determining the one or more anomalies are related to the cascading fault or the one or more anomalies corresponding to an evidence of the cyberattack within the avionics and vetronics network upon determining the one or more anomalies are not related to the cascading fault. The component failure corresponds to an abnormal behavior or breakdown of the one or more components within the avionics and vetronics network. The evidence of the cyberattack corresponds to interference, disruption, malfunction, or compromise of the one or more components caused by cyber threats such as hacking, malware, or other forms of cyberattacks.

Further, the non-transitory machine-readable information storage medium may comprise one or more instructions which when executed by the at least one processor 200 cause the at least one processor 200 to generate one or more alerts for a user associated with the one or more anomalies, upon determining that the one or more anomalies correspond to the component failure or evidence of the cyberattack. The one or more alerts comprise at least one of visual alerts, auditory alerts, textual alerts, tactile alerts, or remote alerts. Further, the non-transitory machine-readable information storage medium may comprise one or more instructions which when executed by the at least one processor 200 cause the at least one processor 200 to display the one or more alerts to the user, for taking an appropriate action in response to the one or more anomalies determined within the avionics and vetronics network.

The present disclosure streamlines the process of determining the one or more anomalies in the avionics and vetronics network. Embodiments of the present invention may ensure a precise analysis of the one or more anomalies using the condition-based maintenance model 204 and the cyber-defense model 206. Embodiments of the present invention may determine the cascading fault. Embodiments of the present invention may improve detection of the component failure and the evidence of the cyberattack within the avionics and vetronics network. Embodiments of the present invention may alert the user about the component failure and the evidence of the cyberattack by generating the one or more alerts for the user.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method comprising:
monitoring, via at least one processor, data of one or more components within a cyber-physical system in real time;
determining, via the at least one processor, one or more anomalies from the monitored data using a condition-based maintenance model and a cyber-defense model, wherein the condition-based maintenance model and the cyber-defense model are configured to determine unexpected behaviors in the data representing component failure and an evidence of a cyberattack respectively, within the cyber-physical system;
determining, via the at least one processor, whether the one or more anomalies is related to a cascading fault using the condition-based maintenance model and the cyber-defense model, wherein the cascading fault corresponds to a sequence of failures of the one or more components within the cyber-physical system;
determining, via the at least one processor, the one or more anomalies corresponding to a component failure within the cyber-physical system upon determining the one or more anomalies are related to the cascading fault or the one or more anomalies corresponding to the evidence of cyberattack upon determining the one or more anomalies are not related to the cascading fault; and
generating, via the at least one processor, one or more alerts for a user associated with the one or more anomalies, upon determining that the one or more anomalies correspond to the component failure or the evidence of the cyberattack.

2. The method of claim 1, wherein the one or more components comprises at least one of a flight control module, a navigation module, a communication module, a surveillance and monitoring module, a weather module, a safety and alerting module, and an engine monitoring module.

3. The method of claim 1, wherein the one or more anomalies correspond to at least one of test information, faults and interrupts in bus, disordering of communications, memory footprint of devices within the avionics and vetronics network, communication timing, contents within packet moving back and forth.

4. The method of claim 1, wherein the component failure corresponds to an abnormal behavior or breakdown of the one or more components within the cyber-physical system.

5. The method of claim 1, wherein the evidence of the cyberattack corresponds to interference, disruption, malfunction, or compromise of the one or more components caused by cyber threats such as hacking, malware, or other forms of cyberattacks.

6. The method of claim 1 further comprising displaying, via the at least one processor, the one or more alerts to the user, for taking an appropriate action in response to the one or more anomalies determined cyber-physical system.

7. The method of claim 1, wherein the one or more alerts comprise at least one of visual alerts, auditory alerts, textual alerts, tactile alerts, or remote alerts.

8. A system comprising:
a memory; and
at least one processor communicatively coupled to the memory, wherein the at least one processor is configured to:
monitor data of one or more components within a cyber-physical system in real time;
determine one or more anomalies from the monitored data using a condition-based maintenance model and a cyber-defense model, wherein the condition-based maintenance model and the cyber-defense model are configured to determine unexpected behaviors in the data representing component failure and an evidence of a cyberattack respectively, within the cyber-physical system;
determine whether the one or more anomalies is related to a cascading fault using the condition-based maintenance model and the cyber-defense model, wherein the cascading fault corresponds to a sequence of failures of the one or more components within the cyber-physical system;
determine the one or more anomalies corresponding to a component failure within the cyber-physical system upon determining the one or more anomalies are related to the cascading fault or the one or more anomalies corresponding to the evidence of the cyberattack upon determining the one or more anomalies are not related to the cascading fault; and
generate one or more alerts for a user associated with the one or more anomalies, upon determining that the one or more anomalies correspond to the component failure or evidence of the cyberattack.

9. The system of claim 8, wherein the one or more components comprises at least one of a flight control module, a navigation module, a communication module, a surveillance and monitoring module, a weather module, a safety and alerting module, and an engine monitoring module.

10. The system of claim 8, wherein the one or more anomalies correspond to at least one of test information, faults and interrupts in bus, disordering of communications, memory footprint of devices within the avionics network, communication timing, contents within packet moving back and forth within the cyber-physical system.

11. The system of claim 8, wherein the component failure corresponds to an abnormal behavior or breakdown of the one or more components within the cyber-physical system.

12. The system of claim 8, wherein the evidence of the cyberattack corresponds to interference, disruption, malfunction, or compromise of the one or more components caused by cyber threats such as hacking, malware, or other forms of cyberattacks.

13. The system of claim 8, wherein the at least one processor is configured to display the one or more alerts to the user, for taking an appropriate action in response to the one or more anomalies determined within the cyber-physical system.

14. The system of claim 8, wherein the one or more alerts comprise at least one of visual alerts, auditory alerts, textual alerts, tactile alerts, or remote alerts.

15. A non-transitory machine-readable information storage medium comprising one or more instructions which when executed by at least one processor causes the at least one processor to:
monitor data of one or more components within a cyber-physical system in real time;
determine one or more anomalies from the monitored data using a condition-based maintenance model and a cyber-defense model, wherein the condition-based maintenance model and the cyber-defense model are configured to determine unexpected behaviors in the data representing component failure and an evidence of a cyberattack respectively, within the cyber-physical system;
determine whether the one or more anomalies is related to a cascading fault using the condition-based maintenance model and the cyber-defense model, wherein the cascading fault corresponds to a sequence of failures of the one or more components within the cyber-physical system;
determine the one or more anomalies corresponding to a component failure within the cyber-physical system upon determining the one or more anomalies are related to the cascading fault or the one or more anomalies corresponding to the evidence of the cyberattack upon determining the one or more anomalies are not related to the cascading fault; and
generate one or more alerts for a user associated with the one or more anomalies, upon determining that the one or more anomalies correspond to the component failure or the evidence of the cyberattack.

16. The non-transitory machine-readable information storage medium of claim 15, wherein the one or more components comprises at least one of a flight control module, a navigation module, a communication module, a surveillance and monitoring module, a weather module, a safety and alerting module, and an engine monitoring module.

17. The non-transitory machine-readable information storage medium of claim 15, wherein the one or more anomalies correspond to at least one of test information, faults and interrupts in bus, disordering of communications, memory footprint of devices within the avionics network, communication timing, contents within packet moving back and forth within the cyber-physical system.

18. The non-transitory machine-readable information storage medium of claim 15, wherein the component failure corresponds to an abnormal behavior or breakdown of the one or more components within the cyber-physical system.

19. The non-transitory machine-readable information storage medium of claim 15, wherein the evidence of the cyberattack corresponds to interference, disruption, malfunction, or compromise of the one or more components caused by cyber threats such as hacking, malware, or other forms of cyberattacks.

20. The non-transitory machine-readable information storage medium of claim 15, wherein the at least one processor is configured to display the one or more alerts to the user, for taking an appropriate action in response to the one or more anomalies determined within the cyber-physical system, wherein the one or more alerts comprise at least one of visual alerts, auditory alerts, textual alerts, tactile alerts, or remote alerts.
